(19) United States
(12) Patent Application Publication
(10) Pub. No.: US 2007/0241720 A1
(43) Pub. Date: Oct. 18, 2007

(54) Inverter system

(75) Inventors: Kiyoshi Sakamoto, Hitachi (JP); Shigehisa Aoyagi, Hitachi (JP); Takahiro Suzuki, Tokai (JP)

Correspondence Address: CROWELL & MORING LLP;INTELLECTUAL PROPERTY GROUP, P.O. BOX 14300, WASHINGTON, DC, 20044-4300, US

(73) Assignee: HITACHI, LTD., Chiyoda-ku (JP)

(21) Appl. No.: 11/698,214

(22) Filed: Jan. 26, 2007

(30) Foreign Application Priority Data
Mar. 27, 2006 (JP) 2006-084446

(51) Int. Cl. H02P 27/04

(52) U.S. Cl. 318/811

(57) ABSTRACT

When finding a current on an AC side of an inverter by observing that on a DC side, a current that is not affected by pulsating components contained in the AC current must be detected. Timing of change of a gate signal for driving a switch element of a phase having an intermediate magnitude among three-phase voltage command signals to ON/OFF is used as a reference time point for DC bus current detection. DC bus currents sampled T1 before and T2 after the reference time point are designated as IDC1 and IDC2, respectively. A detected current value of a maximum voltage phase is computed by using IDC2 and IDC1 respectively in an increase period and a decrease period of a carrier signal alternately. A detected current value of a minimum voltage phase is computed by using IDC1 and IDC2 respectively in an increase period and a decrease period alternately.

### BACKGROUND OF THE INVENTION

The present invention relates to a current detection method for an inverter which drives a synchronous motor or an induction motor.

The inverter is an apparatus for converting a DC voltage to an AC voltage by using the pulse width modulation. The inverter is widely used to drive an AC motor such as a synchronous motor or an induction motor.

The AC output current of the inverter has a waveform obtained by superposing a high frequency pulsating component on an AC fundamental wave component. (By the way, the pulsating component is a component generated because the output voltage of the inverter is subjected to pulse width modulation.) The magnitude of the generated torque of the driven motor depends upon the magnitude and phase of the fundamental wave component of the AC current. When controlling the generated torque of the motor with high precision, therefore, it becomes necessary to extract only the fundamental wave component of the AC current so as not be affected by the pulsating component.

As for the technique for extracting the fundamental wave component of the current when observing the AC output current of the inverter by using a current sensor, it is sufficient according to JP-A-06-189578 to detect an instantaneous value of a phase current of each phase at each of positive and negative maximum amplitude time points of the carrier signal.

### SUMMARY OF THE INVENTION

In the typical motor drive system using the AC current sensor, the fundamental wave component of the AC current can be extracted according to the method described in JP-A-06-189578 as described above.

For example, FIG. 8 shows an AC current waveform obtained when a permanent magnet synchronous motor is driven by a driver. It is appreciated that the motor current has pulsating components superposed thereon. FIG. 9 shows an enlarged view of a current waveform during a period illustrated in FIG. 8. Besides the AC current waveform, a DC bus current and a carrier signal used for pulse width modulation are shown in FIG. 9. In FIG. 9, an instantaneous value of a phase current of each phase is detected at each of positive and negative maximum amplitude time points of the carrier signal. Sample points of the current are represented by circle marks. It is appreciated that the detected current values are equal to the current fundamental component represented by a dotted line.

On the other hand, in a method of finding the current on the AC side by observing the DC bus current of the inverter, the DC side current must be sampled in a state in which the inverter output voltage vector is not the zero vector. Therefore, the observation is affected by the pulsating components and it is difficult to detect the fundamental wave component of the AC current.

FIG. 10 shows detected current values obtained when the motor current is acquired from the DC bus current. It is now supposed that a U-phase current is detected from the DC bus current as the motor current. Under the condition of FIG. 10, a U-phase voltage command VU is the greatest signal among three-phase voltage command signals. In a period during which the U-phase output voltage is positive and output voltages of the V-phase and the W-phase are negative, information of the U-phase current is obtained from the DC bus current. FIG. 10 shows an example in which the DC bus current is taken in at timing in latter half of a period during which the information of the U-phase current is obtained. In this case, it is appreciated that the sample points of the current do not coincide with the fundamental wave component of the current and substantially constant errors appear.

In order to solve the problem described heretofore, there is a technique of conducting estimation computation for the magnitude of the pulsating components in the current and conducting compensation so as to cancel the pulsating components contained in the detected values of the AC current. Since the estimation computation for the pulsating components is newly needed, however, there is a problem that the technique cannot be applied to a drive system which uses a general-purpose microcomputer having low computation processing performance.

An object of the present invention is to provide a current detection method of observing the DC bus current of the inverter and finding the AC output current without being influenced by pulsating components contained in the AC current.

Another object of the present invention is to provide a current detection method capable of improving the precision of the motor output torque by detecting the fundamental wave component from the motor current containing pulsating components and using it for control.

If the detection timing of the DC bus current is suitably chosen, it is possible in principle to detect the fundamental wave component of the current from the DC bus current. Because a current value close to the fundamental wave component of the current indicated by a dotted line can be detected by shifting the current detection timing to earlier in time than the case shown in FIG. 10 as appreciated from the example of the U-phase current detection shown in FIG. 10. Since combinations of the amplitude and phase of the three-phase voltage command signal are diverse, however, it is expected that the computation of the detection timing becomes very complicated. Therefore, it is considered that this approach cannot be applied to the drive system which uses the general-purpose microcomputer having low computation processing performance for the purpose of control.

Therefore, the present inventors have advanced the study in a different approach. As a result, the present inventors have found a feature that the sense (sign) of the pulsating components contained in the detected value of the current depends upon whether the period is a period during which the carrier signal increases or a period during which the carrier signal decreases if the sampling timing of the DC bus current is determined according to a method described later. Utilizing this feature, influences of the pulsating components can be cancelled by using detected current values in the carrier signal increasing period and detected current values in the carrier signal decreasing period alternately and conducting averaging by using the moving average processing and the low pass filter processing.

In addition, the present inventors have found that the above-described effect of canceling the influences of the pulsating components becomes higher as the sampling timing of the DC bus current approaches the time when a gate signal that drives a switch element of a phase having an intermediate magnitude among the three phase voltage command signals changes to ON or OFF.

In accordance with the present invention, an inverter system includes a PWM controller for conducting pulse width modulation on three-phase voltage command signals by using a carrier signal, an inverter driven by gate signals subjected to the pulse width modulation, and current detection means for detecting a DC bus current of the inverter, and in the inverter system, time when a gate signal that drives a switch element of a phase having an intermediate magnitude among the three-phase voltage command signals changes to ON or OFF is used as a reference time point for DC bus current detection, and the inverter is controlled by using a DC bus current value sampled in vicinity of the reference time point located before or after the reference time point.

As a result, even in a system in which the AC output current is found by observing the DC bus current of the inverter, the fundamental wave component of the AC current can be found with high precision.

Other objects, features and advantages of the invention will become apparent from the following description of the embodiments of the invention taken in conjunction with the accompanying drawings.

### BRIEF DESCRIPTION OF THE DRAWINGS

FIG. 1 is a general control block diagram which schematically shows a drive system of a permanent magnet synchronous according to an embodiment of the present invention;

FIG. 2 is a diagram for explaining detection timing of a DC bus current in the embodiment;

FIG. 3 is a diagram showing relations between sample timing of a phase current of a maximum voltage phase and a DC bus current and their sample values in the embodiment;

FIG. 4 is a diagram showing an example of a DC bus current detection method corresponding to a raised frequency of the carrier signal;

FIG. 5 is a diagram showing another example of the DC bus current detection method corresponding to the raised frequency of the carrier signal;

FIG. 6 is a diagram showing a relation between an actual motor current and detected current values obtained when the DC bus current is detected according to the method shown in FIG. 4;

FIG. 7 is a diagram showing a control configuration of a speed control system for the motor;

FIG. 8 is a diagram showing a motor current waveform;

FIG. 9 is a diagram showing a relation between sample timing and sample values obtained when an instantaneous value of a phase current is detected at each of positive and negative maximum amplitude time points of the carrier signal; and

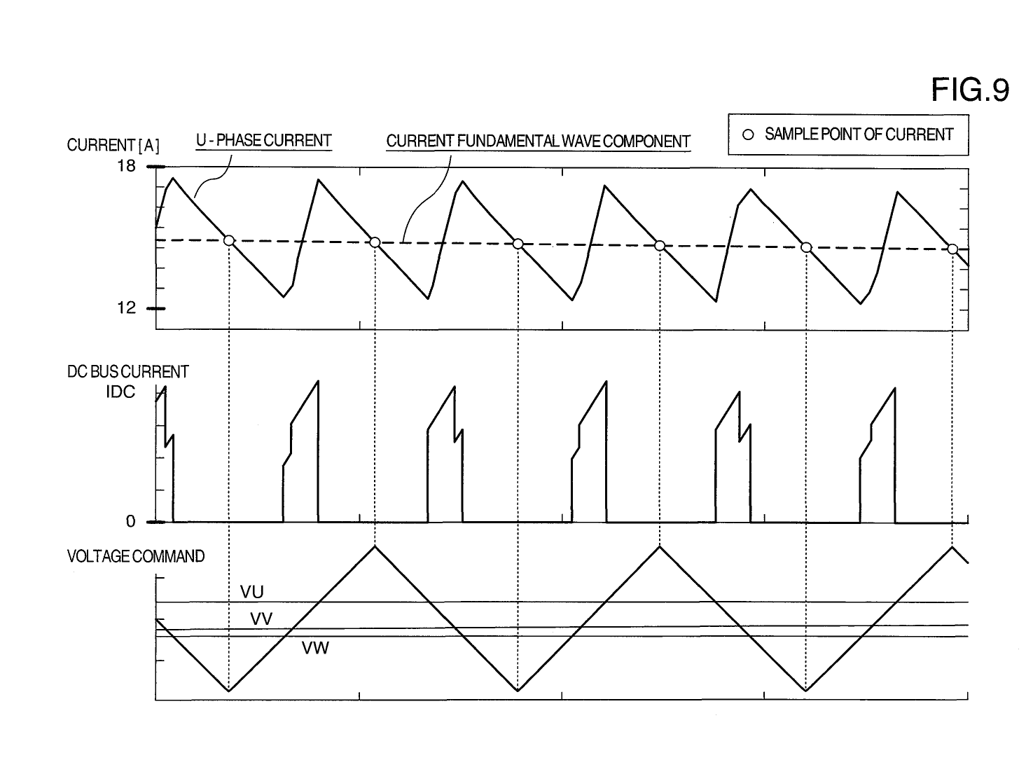

FIG. 10 is a diagram showing relations between sample timing and sample values obtained when the DC bus current is sampled in a latter half of a period in which a phase current of a maximum voltage phase is obtained.

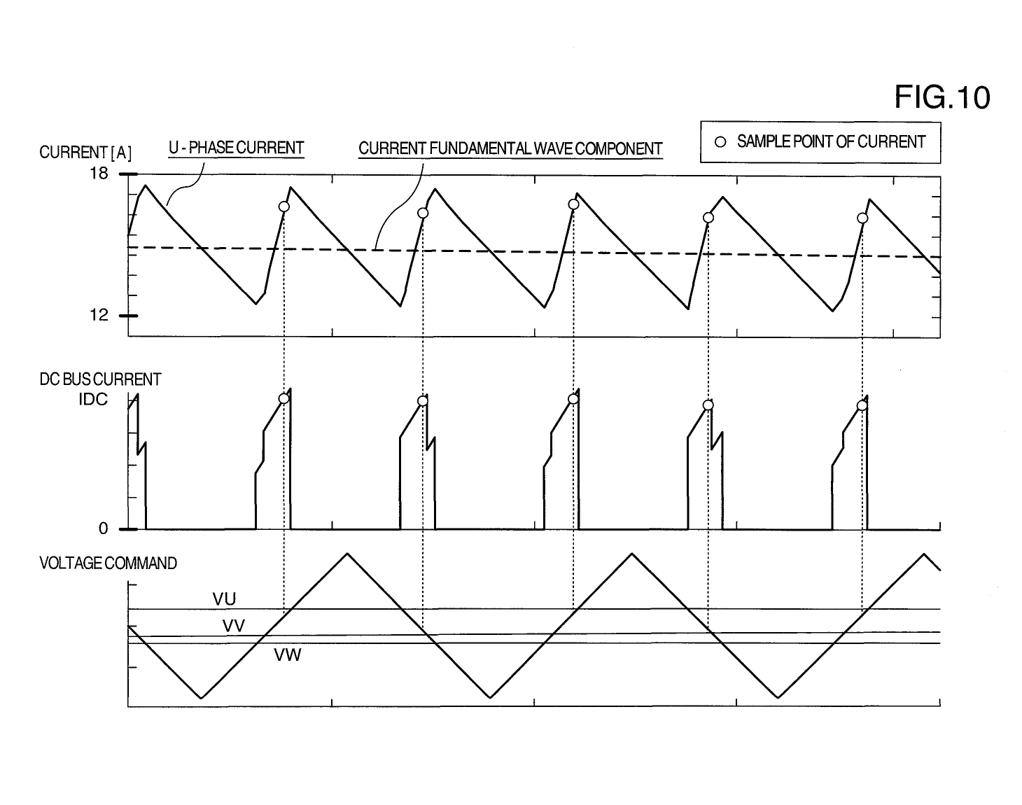

### DESCRIPTION OF THE EMBODIMENTS

Hereafter, an embodiment of the present invention will be described in detail with reference to the drawings.

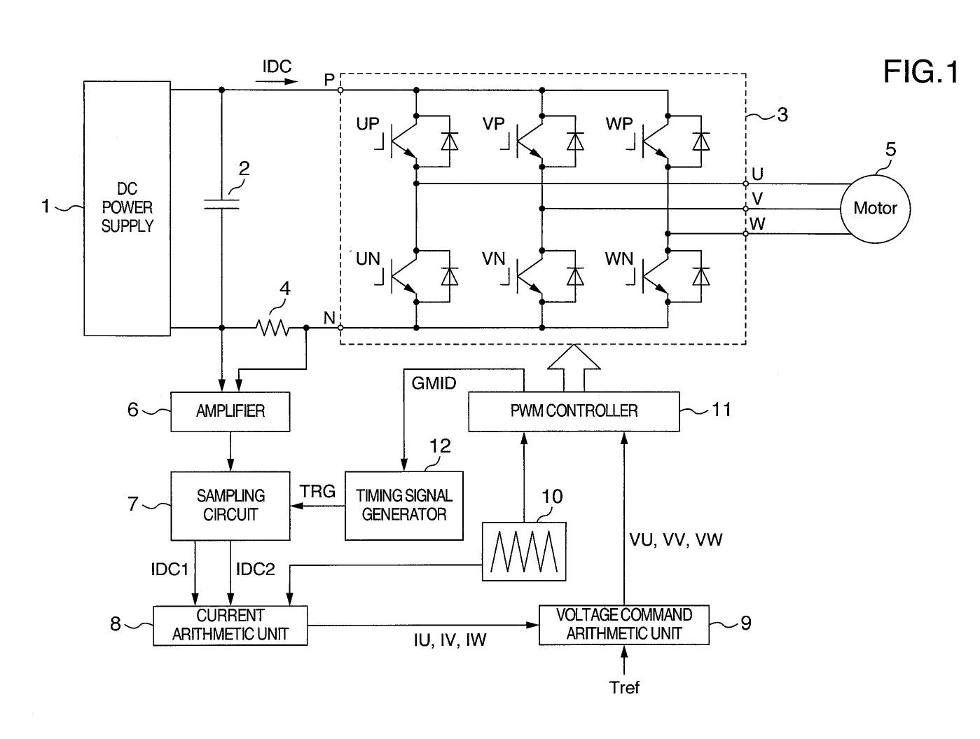

FIG. 1 shows a configuration of the present embodiment. A capacitor 2 for DC voltage smoothing is connected between a positive side terminal and a negative side terminal of a DC power supply 1. A DC positive side terminal P of an inverter 3 is connected to a positive side terminal of the capacitor 2. A DC negative side terminal N of the inverter 3 is connected to a negative side terminal of the capacitor 2 via a DC shunt resistor 4. AC terminals of an AC motor 5 to be controlled are connected to AC output terminals U, V and W of the inverter 3. The AC motor 5 is driven with power supplied by the inverter 3. A voltage is generated across the DC shunt resistor 4 by a current IDC flowing through a DC bus. An amplifier 6 amplifies the voltage across the DC shunt resistor 4. In FIG. 1, the DC shunt resistor 4 is attached to a DC bus of negative side. Even if the DC shunt resistor 4 is attached to a DC bus of positive side, however, the invention described hereafter can be applied in the same way.

An output signal of the amplifier 6 is sampled by a sampling circuit 7. As for timing of the sampling, sampling is conducted when a trigger signal TRG described later has changed to its H level. A result of the sampling is output as IDC1 or IDC2. A current arithmetic unit 8 outputs detected current values IU, IV and IW on the basis of IDC1, IDC2 and increase/decrease information of the carrier signal described later. A voltage command arithmetic unit 9 outputs three-phase voltage command signals VU, VV and VW on the basis of a torque command value Tref supplied from the outside and the detected current values IU, IV and IW. A carrier signal generator 10 generates a carrier signal to be used for pulse width modulation control. A pulse width modulation controller 11 outputs pulse width modulated gate signals on the basis of the three-phase voltage command signals VU, VV and VW and the carrier signal. The gate signals thus output are used to control ON/OFF of switch elements UP, UN, VP, VN, WP and WN in the inverter 3.

In addition, the pulse width modulation controller 11 outputs a gate signal for driving a switch element of a phase (hereafter referred to simply as intermediate voltage phase) having an intermediate magnitude among the three-phase voltage command signals as a signal GMID to determine sampling timing of the DC bus current. A timing signal generator 12 outputs a trigger signal TRG. The trigger signal TRG determines sampling timing of the DC bus current on the basis of timing of the change of the signal GMID to ON or OFF, and changes it to the level of the trigger signal.

The operation principle of the present embodiment will now be described.

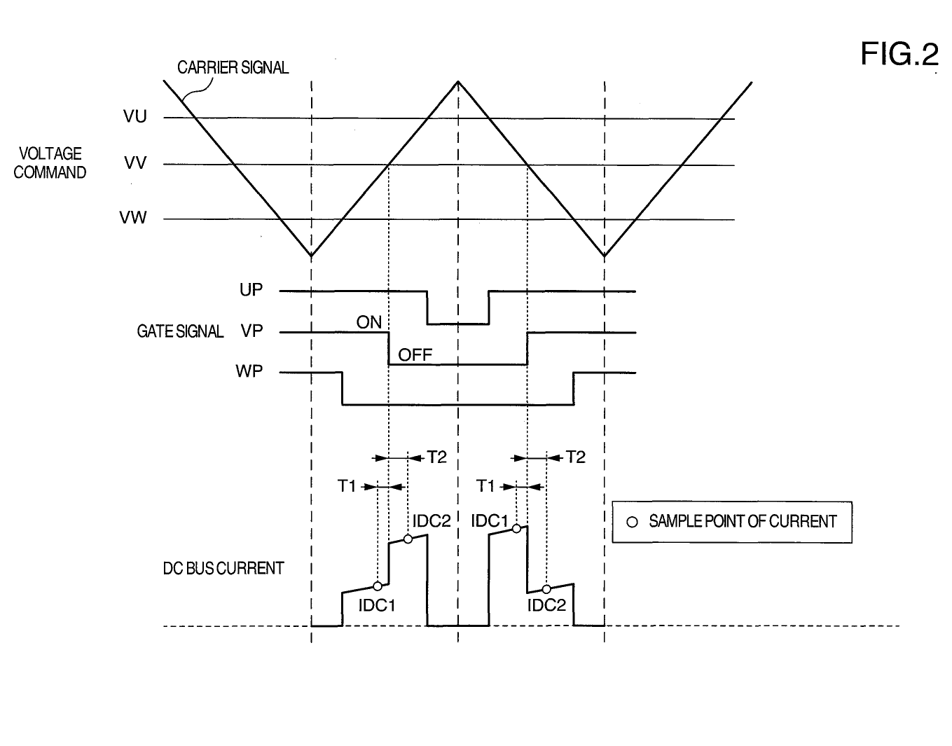

FIG. 2 is a diagram for explaining detection timing of the DC bus current in the sampling circuit 7 of the present embodiment. In FIG. 2, the three-phase voltage command signals have the V-phase as the intermediate voltage phase. In this case, change timing of the gate signal VP for driving the switch element of the V-phase, i.e., timing of change from ON to OFF or timing of change from OFF to ON is used as a reference time point for DC bus current detection. A DC bus current sampled at a time point that is a predetermined time T1 before the reference time point is designated as a first DC current value IDC1. A DC bus current sampled at a time point that is a predetermined time T2 after the reference time point is designated as a second DC current value IDC2.

In the present invention, the predetermined time T1 and the predetermined time T2 are made short as far as possible, and the DC current value IDC1 and the DC current value IDC2 are sampled in the vicinity of timing of change between ON and OFF in the gate signal that drives the switch element of the intermediate voltage phase.

However, the predetermined time T1 and the predetermined time T2 cannot be made short without any restriction. Immediately after a current path of the inverter circuit has changed due to switching of the switch element of the intermediate voltage phase, high frequency vibration components are superposed on the current of the DC bus. Therefore, it is necessary to set the predetermined time T2 by considering a time required to wait until the high frequency vibration in the DC bus current attenuates and the amplitude of the vibration becomes sufficiently small. Although not shown in FIG. 2 in detail, a dead time period is provided in the gate signals in order to avoid simultaneous conduction of a pair of switch elements connected in series in the inverter.

For example, timing of the change of the gate signal VP of the intermediate voltage phase between ON and OFF is shown in FIG. 2. However, timing of the change of a gate signal VP paired with the gate signal VP between ON and OFF is not the same as that of the gate signal VP, but is deviated by the dead time period. As a result, it depends on the polarity of the motor current whether the current path in the inverter changes at the change timing of the gate signal VP or changes at the change timing of the gate signal VN. If the current polarity information is not obtained, therefore, the change of the current path cannot be predicted. Therefore, it is necessary to make the sum of T1 and T2 at least longer than the sum of the dead time period and a period taken until the high frequency vibration of the DC current attenuates and the vibration amplitude becomes a predetermined value or less.

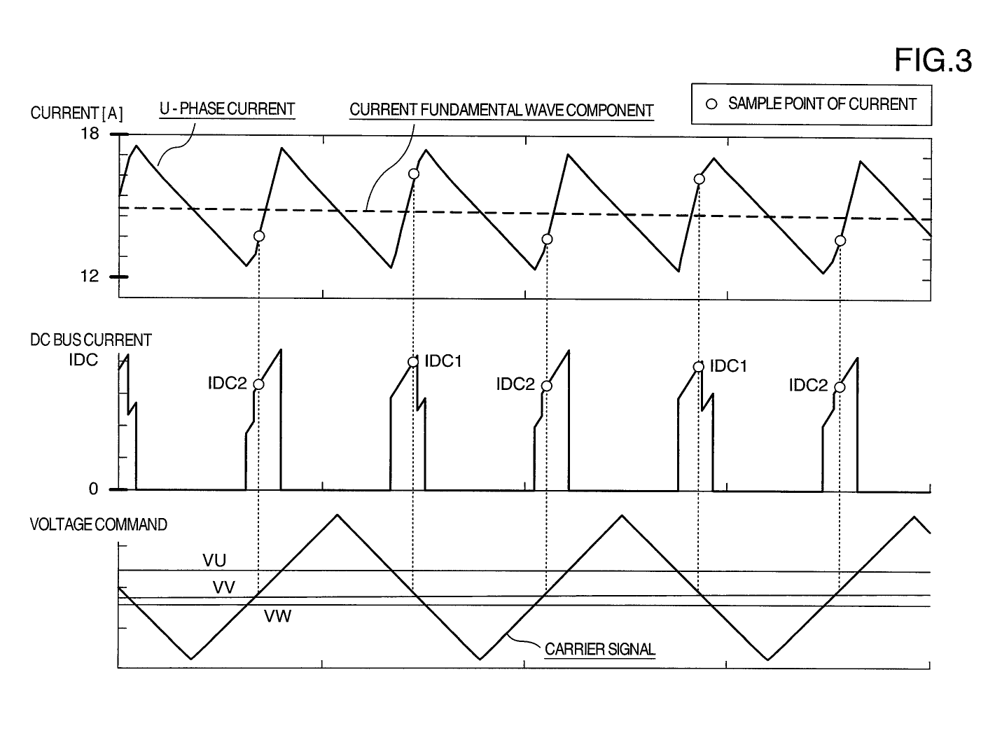

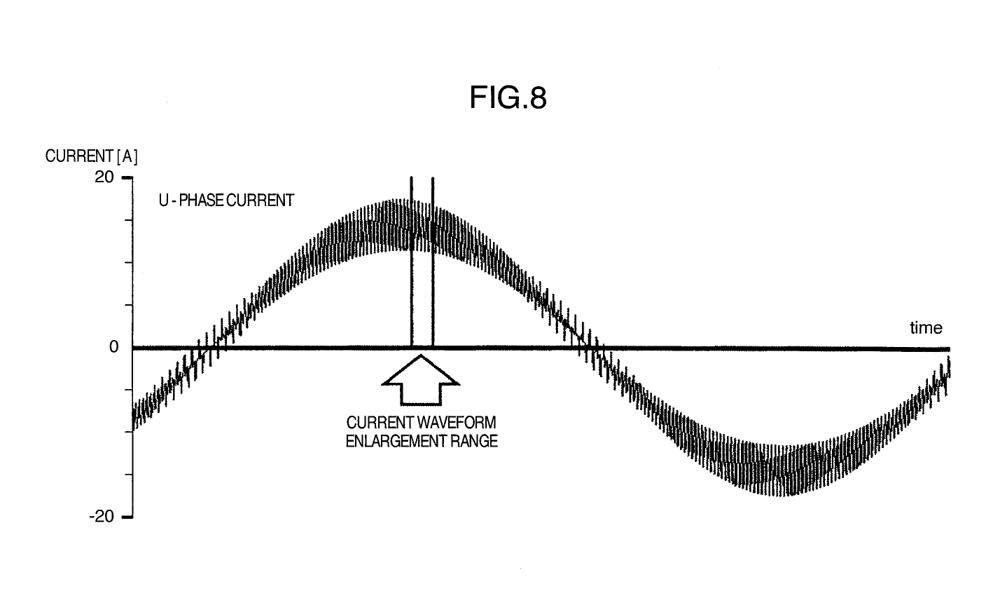

FIG. 3 is a diagram showing relations between sample timing of the phase current of the maximum voltage phase and the DC bus current and their sample values in the present embodiment. The motor current shown in FIG. 3 is an enlarged view of the motor current simulation waveform shown in FIG. 8.

In the present invention, the DC current value IDC1 and the DC current value IDC2 are sampled in the vicinity of timing of change between ON and OFF in the gate signal that drives the switch element of the intermediate voltage phase as described above. As for the detection of the DC current values IDC1 and IDC2 shown in FIG. 3, it is appreciated that not the fundamental wave component of the U-phase current but a current subjected to influence of the pulsating component is detected. Specifically, in the case of FIG. 3, a current smaller than the fundamental wave component is detected for IDC2 in the increase period of the carrier signal, and a current larger than the fundamental wave component is detected for IDC1 in the decrease period of the carrier signal.

Utilizing this characteristic, influences of the pulsating components contained in the AC current are canceled in the current arithmetic unit 8 in the present embodiment when detecting the phase current of the maximum voltage phase by detecting IDC2 in the increase period of the carrier signal and IDC1 in the decrease period of the carrier signal alternately and computing the average value of IDC2 and IDC1. Besides the average value computation, it is also possible to detect IDC2 in the increase period of the carrier signal and IDC1 in the decrease period of the carrier signal alternately and conduct the moving average computation on detected values or pass the detected values through a low pass filter. Since influences of the pulsating components contained in the detected values generate high frequency components, they can be attenuated by passing the detected values through the low pass filter. It is also possible to detect IDC2 in the increase period of the carrier signal and IDC1 in the decrease period of the carrier signal alternately and use detected values as feedback values of the motor current control system as they are. Because in the current control system the transfer characteristics ranging from the current feedback value to the actual current are in general close to the low pass filter characteristics, and consequently the amplitude of pulsating components contained in the detected value can be attenuated.

Although description is omitted, influences of the pulsating components contained in the AC current can be canceled in the present embodiment in the same way when detecting the phase current of the minimum voltage phase by detecting IDC1 in the increase period of the carrier signal and IDC2 in the decrease period of the carrier signal alternately and using the average value computation of IDC1 and IDC2 or the low pass filter.

An analog-digital converter (hereafter referred to as A-D converter) is used in sampling of the DC bus current conducted by the sampling circuit 7. In general, in the A-D converter, sampling and digital conversion of the input signal require a predetermined time. If the frequency of the pulse width modulation carrier signal has become high, therefore, it becomes impossible to sample a current pulse appearing on the DC bus each time. Therefore, it is necessary to reduce the number of times of detection by detecting the current pulse on the DC bus once every several times. In this case as well, influences of the pulsating components can be canceled by using current detected values in the increase period of the carrier signal and current detected values in the decrease period of the carrier signal alternately and averaging them.

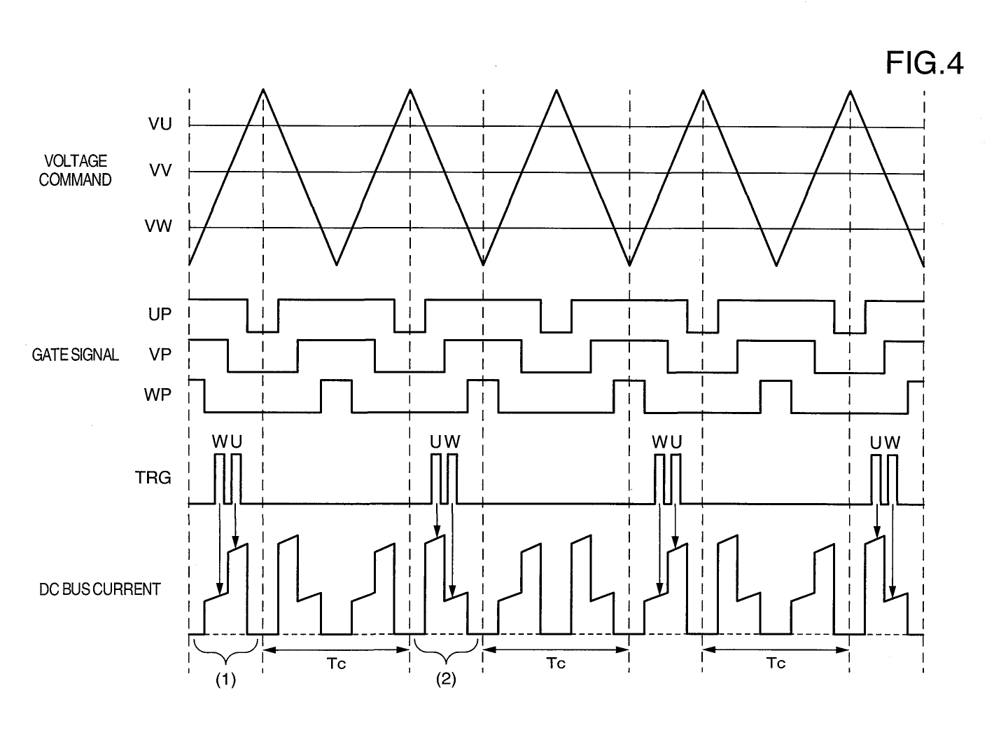

FIG. 4 shows an example of a DC bus current detection method corresponding to a raised frequency of the carrier signal. In FIG. 4, W-phase current information is detected from IDC1 and U-phase current information is detected from IDC2 in the increase period of the carrier signal ((1) in FIG. 4) in order to detect phase currents of the maximum voltage phase U and the minimum voltage phase W. When one period time Tc of the carrier signal has elapsed after the period (1) is over, U-phase current information is detected from IDC1 and W-phase current information is detected from IDC2 in the decrease period of the carrier signal ((2) in FIG. 4). Influences of the pulsating components contained in the AC current can be canceled by repeating (1) and (2) alternately and using the average value computation or the low pass filter.

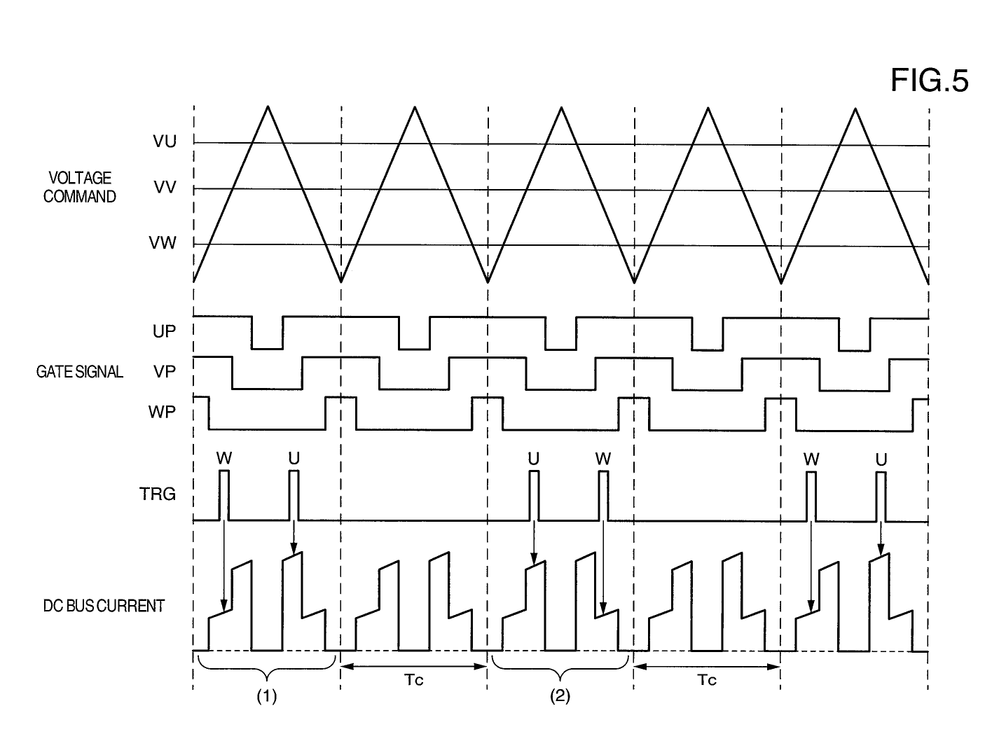

FIG. 5 shows another example of a DC bus current detection method corresponding to a raised frequency of the carrier signal. In the case of the present scheme, in a carrier period (1) shown in FIG. 5, W-phase current information is obtained from IDC1 in an increase period of the carrier signal and U-phase current information is obtained from IDC1 in a decrease period of the carrier signal. When one period time Tc of the carrier signal has elapsed after the period (1) is over, U-phase current information is obtained from IDC2 in an increase period of the carrier signal and W-phase current information is obtained from IDC2 in a decrease period of the carrier signal, in a carrier period (2) shown in FIG. 5. Influences of the pulsating components contained in the AC current can be canceled by repeating (1) and (2) alternately and using the average value computation or the low pass filter.

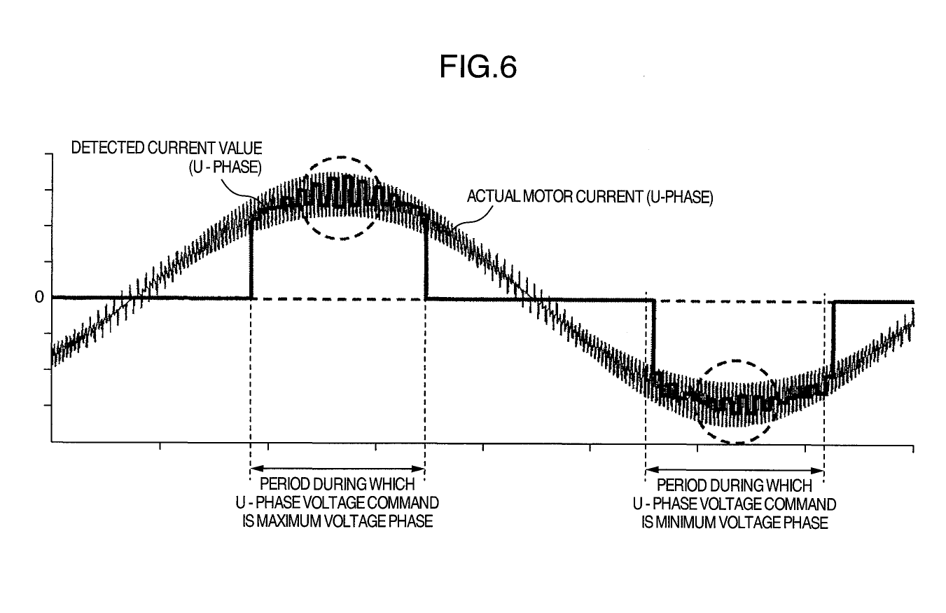

FIG. 6 shows a relation between an actual motor current and detected current values obtained when the DC bus current is detected according to the method shown in FIG. 4. U-phase current information is obtained from the DC bus current in a period in which the U-phase voltage command is the maximum voltage phase and in a period in which the U-phase voltage command is the minimum voltage phase. Therefore, the waveform is drawn regarding the detected current values as zero in a period in which U-phase current information is not obtained.

In FIG. 6, the detected current value represented by a thick solid line has large and remarkable differences in level in a portion surrounded by a dotted line circle. The reason can be explained as follows: depending upon whether the detected DC bus current value in the increase period of the carrier signal is used or the detected DC bus current value in the decrease period of the carrier signal is used, the amplitude of the pulsating components contained in the detected value changes and the difference between detected values becomes large. If the averaging computation or the low pass filter is used, however, influences of pulsating components contained in the AC current can be canceled and values close to the fundamental wave component of the actual motor current are obtained.

According to the embodiment of the present invention heretofore described, influences of pulsating components contained in the AC current can be canceled and consequently the fundamental wave component of the AC current can be found with high precision, even in a scheme in which the AC output current is found by observing the DC bus current of the inverter.

The AC current information obtained by detection becomes close to the value of the AC fundamental wave component. When estimating a torque generated by the motor on the basis of the detected current, therefore, the estimated value becomes more accurate. Especially, when a “torque control system” which controls the torque generated by the motor in response to a torque command given from the outside is formed, the precision of the generated torque becomes high.

In addition, the present invention is also effective to the case where the inverter is controlled for the purpose other than torque control.

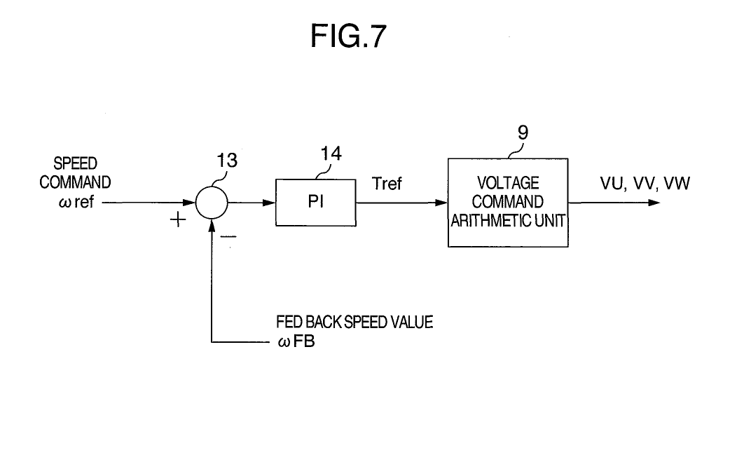

For example, FIG. 7 shows a control configuration of a motor speed control system. An error between a speed command ωref given from the outside and a feedback speed value ωFB of the motor speed is computed by an arithmetic unit 13. A PI control compensator 14 is supplied with the error as an input signal, and the PI control compensator 14 outputs a torque command Tref. The configuration of the part subsequent to the torque command Tref is the same as the control configuration shown in FIG. 1.

In the case of the speed control system, torque control is included in the inner control loop. Even if the precision of the torque control is poor, a speed error is not caused by an outer speed compensation loop. If the precision of the torque control is poor, however, there is a problem that a command value follow-up response or a disturbance suppression response does not have a speed designed previously. According to the embodiment of the present invention, the precision of the torque control can be improved and consequently the command value tracking response or the disturbance suppression response can be made as designed.

In the drawings, the three-phase voltage command signals VU, VV and VW are drawn as DC quantities. When driving the AC motor, therefore, the three-phase voltage command signals become AC quantities. Therefore, the maximum voltage phase, the intermediate voltage phase and the minimum voltage phase change according to the progress of the phase of the AC voltage.

In accordance with the present invention, influences of the pulsating components are canceled by using the detected current values in the increase period of the carrier signal and the detected current values in the decrease period of the carrier signal alternately and averaging them. However, it is considered that the canceling effect is reduced before and after the maximum voltage phase, the intermediate voltage phase and the minimum voltage phase of the AC voltage are interchanged. Since the maximum voltage phase, the intermediate voltage phase and the minimum voltage phase of the AC voltage are interchanged six times every period of the AC voltage, however, it is considered that the effect decreases temporarily. Even when AC voltage commands are given, therefore, the effect of the present invention is also obtained in the same way.

According to the embodiment of the present invention, influences of the pulsating components can be canceled and consequently the fundamental wave component of the AC current can be found with high precision, even in the scheme in which the AC output current is found by observing the DC bus current of the inverter.

According to the embodiment of the present invention, information of the AC current obtained by the detection becomes close to a value of the AC fundamental wave component. When estimating the torque generated by the motor on the basis of the detected current, the estimated value becomes more accurate. Especially, when a “torque control system” which controls the torque generated by the motor in response to a torque command given from the outside is formed, the effect that the precision of the generated torque becomes high is brought about.

The inverter system according to the present invention can be used to drive, for example, a motor for washing machine as well.

As known, the washing machine is an apparatus which has a substantially cylindrical washing vessel serving also as dehydration vessel and drives the washing vessel serving also as dehydration vessel or stirring vanes attached in the vessel with a motor. In recent years, it is demanded to hold down noise caused at the time of drive in the washing machine to a low level. Therefore, it has become indispensable to raise the frequency of the carrier signal used in pulse width modulation of the inverter and hold down the electromagnetic sound generated from the motor.

According to the inverter system of the present invention, influences of pulsating components contained in the AC current can be canceled when the DC bus current in the inverter is observed by using the method shown in FIG. 4 or FIG. 5, even if the frequency of the carrier signal is raised. Therefore, the fundamental wave component of the AC current can be controlled with high precision while holding down the electromagnetic sound generated from the motor. As a result, it is possible to raise the quality of drive control of the washing vessel serving also as dehydration vessel or stirring vanes attached in the vessel.

It should be further understood by those skilled in the art that although the foregoing description has been made on embodiments of the invention, the invention is not limited thereto and various changes and modifications may be made without departing from the spirit of the invention and the scope of the appended claims.

1. An inverter system comprising:
a PWM controller for conducting pulse width modulation on three-phase voltage command signals by using a carrier signal;
an inverter driven by gate signals subjected to the pulse width modulation; and
current detection means for detecting a DC bus current of the inverter,
wherein
time when a gate signal that drives a switch element of a phase having an intermediate magnitude among the three-phase voltage command signals changes to ON or OFF is used as a reference time point for DC bus current detection, and
the inverter is controlled by using a DC bus current value sampled in vicinity of the reference time point located before or after the reference time point.

2. A washing machine in which a motor is driven by the inverter system according to claim 1 and stirring vanes are driven by motive power of the motor.

3. An inverter system comprising:
a PWM controller for conducting pulse width modulation on three-phase voltage command signals by using a carrier signal;
an inverter driven by gate signals subjected to the pulse width modulation; and
current detection means for detecting a DC bus current of the inverter,
wherein
time when a gate signal that drives a switch element of a phase having an intermediate magnitude among the three-phase voltage command signals changes to ON or OFF is used as a reference time point for DC bus current detection,
a DC bus current sampled at a time point that is a predetermined time T1 before the reference time point is designated as a first DC current value IDC1,
a DC bus current sampled at a time point that is a predetermined time T2 after the reference time point is designated as a second DC current value IDC2,
a detected value of a current of a phase having a maximum magnitude among the three-phase voltage command signals is computed by using IDC2 in an increase period of the carrier signal and IDC1 in a decrease period of the carrier signal alternately, and
a detected value of a current of a phase having a minimum magnitude among the three-phase voltage command signals is computed by using IDC1 in an increase period of the carrier signal and IDC2 in a decrease period of the carrier signal alternately.

4. The inverter system according to claim 3, wherein a sum of the predetermined time T1 and the predetermined time T2 is made longer than at least a sum of a dead time period provided to avoid simultaneous conduction of a pair of serially connected switches in the inverter and a period taken until high frequency vibration of the DC current caused when a switch element of a phase having an intermediate magnitude among the three-phase voltage command signals is switched attenuates and amplitude of the vibration becomes a predetermined value or less.

5. The inverter system according to claim 3, wherein sampling time points of the DC current IDC1 and the DC current IDC2 are located near the reference time point.

6. The inverter system according to claim 3, wherein the DC current IDC1 and the DC current IDC2 are not used alternately, but an average value or a moving average value of the DC current IDC1 and the DC current IDC2 is used.

7. The inverter system according to claim 3, wherein the DC current IDC1 and the DC current IDC2 are passed through a low pass filter, and computation is conducted by using results alternately.

8. The inverter system according to claim 3, wherein a detection interval between the detection of IDC1 in the increase period of the carrier signal and the detection of IDC2 in the decrease period of the carrier signal and a detection interval between the detection of IDC2 in the increase period of the carrier signal and the detection of IDC1 in the decrease period of the carrier signal are made at least one period of the carrier signal.

9. The inverter system according to claim 3, wherein
the inverter drives a motor, and
the inverter system comprises a voltage command arithmetic unit to output the three-phase voltage command signals on the basis of a torque command value of the motor given from outside.

10. The inverter system according to claim 3, wherein
the inverter drives a motor,
the inverter system comprises means responsive to a speed command value given from outside and a feedback speed value to generate a torque command so as to make a difference between the command value and the feedback speed value small, and
the inverter system comprises a voltage command arithmetic unit to output the three-phase voltage command signals on the basis of a value of the torque command.

11. A washing machine in which a motor is driven by the inverter system according to claim 3 and stirring vanes are driven by motive power of the motor.

12. An inverter system comprising:
a PWM controller for conducting pulse width modulation on three-phase voltage command signals by using a carrier signal;
an inverter driven by gate signals subjected to the pulse width modulation; and
current detection means for detecting a DC bus current of the inverter,
wherein a time interval elapsed between detection of the DC bus current of the inverter in an increase period of the carrier signal and detection of the DC bus current of the inverter in a decrease period of the carrier signal is set equal to at least one period of the carrier signal.

13. A washing machine in which a motor is driven by the inverter system according to claim 12 and stirring vanes are driven by motive power of the motor.
